(19) United States
(12) Patent Application Publication
(10) Pub. No.: US 2017/0168968 A1
(43) Pub. Date: Jun. 15, 2017

(54) AUDIO BUS INTERRUPTS

(71) Applicant: QUALCOMM Incorporated, San Diego, CA (US)

(72) Inventors: Lior Amarilio, Yokneam (IL); Boaz Moskovich, Haifa (IL)

(21) Appl. No.: 14/969,315

(22) Filed: Dec. 15, 2015

(51) Int. Cl. G06F 13/24; G06F 13/42; G06F 13/364

(52) U.S. Cl. CPC G06F 13/24; G06F 13/364; G06F 13/4282

(57) ABSTRACT

Audio bus interrupts are disclosed. In one aspect, a new command (referred to herein as a Slave Interrupt Status command) is provided using a reserved Opcode within the SOUNDWIRE protocol. In response to a Ping Request by a slave, a master generates a PING command. The slave that generated the Ping Request sets a bit in a Ping Response according to the existing SOUNDWIRE protocol. However, instead of iteratively reading from each slave, the master uses the Slave Interrupt Status command to interrogate the requesting slave more thoroughly. In response to the Slave Interrupt Status command, the slave provides a more robust response that indicates interrupt requesting status of all registers within the slave that could generate an interrupt. Thus, the master is provided a complete list of which registers generate the original Ping Request and can act accordingly to address issues that generate the interrupt.

### BACKGROUND

I. Field of the Disclosure

The technology of the disclosure relates generally to audio buses and more particularly to SOUNDWIRE audio buses.

II. Background

Computing devices have become increasingly common in modern society. The popularity of such devices is enhanced by the ever increasing array of options that exist within computing devices. Computing devices are now used to stream audio and video signals, turning such computing devices into home entertainment systems. In addition, the miniaturization of components within computing devices has enabled a revolution in the versatility of mobile computing devices. Such devices have gone from simple phones and calculators to complex multimedia entertainment devices. In conjunction with the expansion of the multimedia options available in computing devices has been an evolution of techniques to handle plural audio speakers. One such technique, the Serial Low-power Inter-chip Multimedia bus (SLIMbus) was introduced by the MIPI® Alliance. In response to a generally tepid industry reception of SLIMbus, the MIPI® Alliance published version 1.0 of the SOUNDWIRE specification on Feb. 27, 2015.

SOUNDWIRE relies on a two-wire time division multiplex protocol to convey signals between a master and plural slave devices. Currently, if a slave experiences a condition that requires attention from the master, the slave uses a shared Ping Request bit in a frame to alert the master about a need to collect updated interrupt status. The master then generates a PING command which queries all slaves on the bus to determine which slave activated the shared Ping Request bit.

In most existing slave architectures, the slave includes a cascaded series of registers that are collectively ORed into a single interrupt Ping Request. Accordingly, once the master knows which slave activated the shared Ping Request bit, the master must determine which register within the slave generated the need for an interrupt. This iterative process requires multiple read requests from the master to the slave as different registers are read. Such iterative reading of registers to find the register that generated the original interrupt introduces latency into the system. Exemplary interrupt requests may be a function of the slave overheating or detection of audio clipping. Neither situation is latency tolerant. Accordingly, there is a desire for a way to allow slaves to generate an interrupt with reduced latency relative to current interrupt schemes.

### SUMMARY OF THE DISCLOSURE

Aspects disclosed in the detailed description include audio bus interrupts. In an exemplary, non-limiting aspect, a new command (referred to herein as a Slave Interrupt Status command) is provided using a reserved Opcode within the SOUNDWIRE protocol. In response to a Ping Request by a slave, a master generates a PING command. The slave that generated the Ping Request sets a bit in a Ping Response according to the existing SOUNDWIRE protocol. However, instead of iteratively reading from each slave, the master uses the Slave Interrupt Status command to interrogate the requesting slave more thoroughly. In response to the Slave Interrupt Status command, the slave provides a more robust response that indicates interrupt requesting status of all registers within the slave that could generate an interrupt. Thus, the master is provided a complete list of which registers generate the original Ping Request and can act accordingly to address issues that generate the interrupt. Elimination of the iterative read process greatly reduces latency. In the event that the interrupt was related to audio clipping, such reduction in latency may improve the user experience by providing better audio quality.

In this regard in one aspect, a master is disclosed. The master includes a bus interface configured to couple to an audio bus. The master also includes a control system operatively coupled to the bus interface. The control system is configured to detect a ping request from a slave associated with the audio bus. The control system is also configured to send a ping command to slaves associated with the audio bus. The control system is also configured to receive slave status information from the slave that generated the ping request. The control system is also configured to send a slave interrupt status command to the slave that generated the ping request. The control system is also configured to receive information about all interrupt registers with the slave that generated the ping request.

In another aspect, a method for generating an interrupt is disclosed. The method includes detecting a ping request from a slave associated with an audio bus. The method also includes sending a ping command to slaves associated with the audio bus. The method also includes receiving a slave status information from the slave that generated the ping request. The method also includes sending a slave interrupt status command to the slave that generated the ping request. The method also includes receiving information about all interrupt registers within the slave that generated the ping request.

In another aspect, a slave is disclosed. The slave includes a bus interface configured to be coupled to an audio bus. The slave also includes an audio component. The slave also includes a control system operatively coupled to the audio component and the bus interface. The control system is configured to set a ping request bit in a frame on the audio bus in response to an interrupt situation being detected within a slave. The control system is also configured to receive a ping command from a master through the audio bus. The control system is also configured to respond to the ping command with a slave status information. The control system is also configured to receive a slave status interrupt command from the master through the audio bus. The control system is also configured to send information about all interrupt registers on the audio bus to the master.

### BRIEF DESCRIPTION OF THE FIGURES

FIG. 1 is a block diagram of an exemplary SOUNDWIRE system having a master and plural slaves;

FIG. 2 illustrates a conventional circuit that provides behavior of an interrupt status logic in a single data port;

FIG. 3 illustrates a conventional circuit that provides the behavior of the interrupt status logic in a slave control port (SCP);

FIG. 4 is a flowchart illustrating a conventional process for detecting which interrupt status logic element within many possible data ports has triggered a particular interrupt;

FIG. 5 is a flowchart illustrating the addition of a slave interrupt status (SIS) command according to an exemplary aspect of the present disclosure;

FIG. 6 illustrates a frame of the slave response to the SIS command; and

FIG. 7 is a block diagram of an exemplary processor-based system that can include the SOUNDWIRE system of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include audio bus interrupts. In an exemplary, non-limiting aspect, a new command (referred to herein as a Slave Interrupt Status command) is provided using a reserved Opcode within the SOUNDWIRE protocol. In response to a Ping Request by a slave, a master generates a PING command. The slave that generated the Ping Request sets a bit in a Ping Response according to the existing SOUNDWIRE protocol. However, instead of iteratively reading from each slave, the master uses the Slave Interrupt Status command to interrogate the requesting slave more thoroughly. In response to the Slave Interrupt Status command, the slave provides a more robust response that indicates interrupt requesting status of all registers within the slave that could generate an interrupt. Thus, the master is provided a complete list of which registers generate the original Ping Request and can act accordingly to address issues that generate the interrupt. Elimination of the iterative read process greatly reduces latency. In the event that the interrupt was related to audio clipping, such reduction in latency may improve the user experience by providing better audio quality.

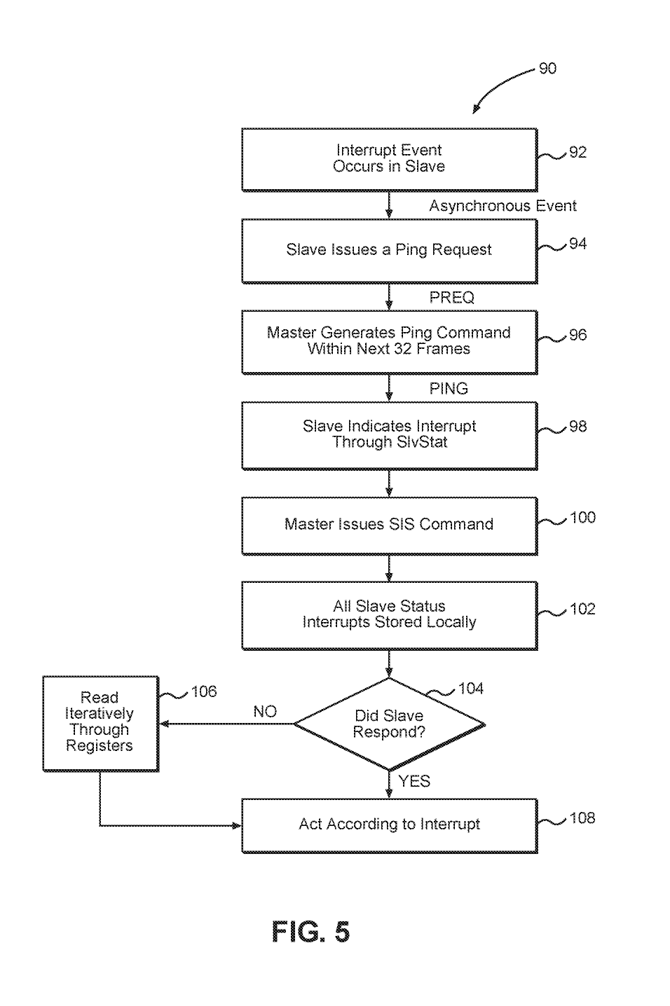

Before addressing particular aspects of the present disclosure, a more detailed description of conventional SOUNDWIRE architecture is provided to assist in appreciation of the benefits provided by exemplary aspects of the present disclosure. In particular, the reduction in latency achieved through using the present disclosure is better illustrated by understanding the current SOUNDWIRE interrupt architecture and processes. A discussion of exemplary aspects of the present disclosure begins below with reference to FIG. 5.

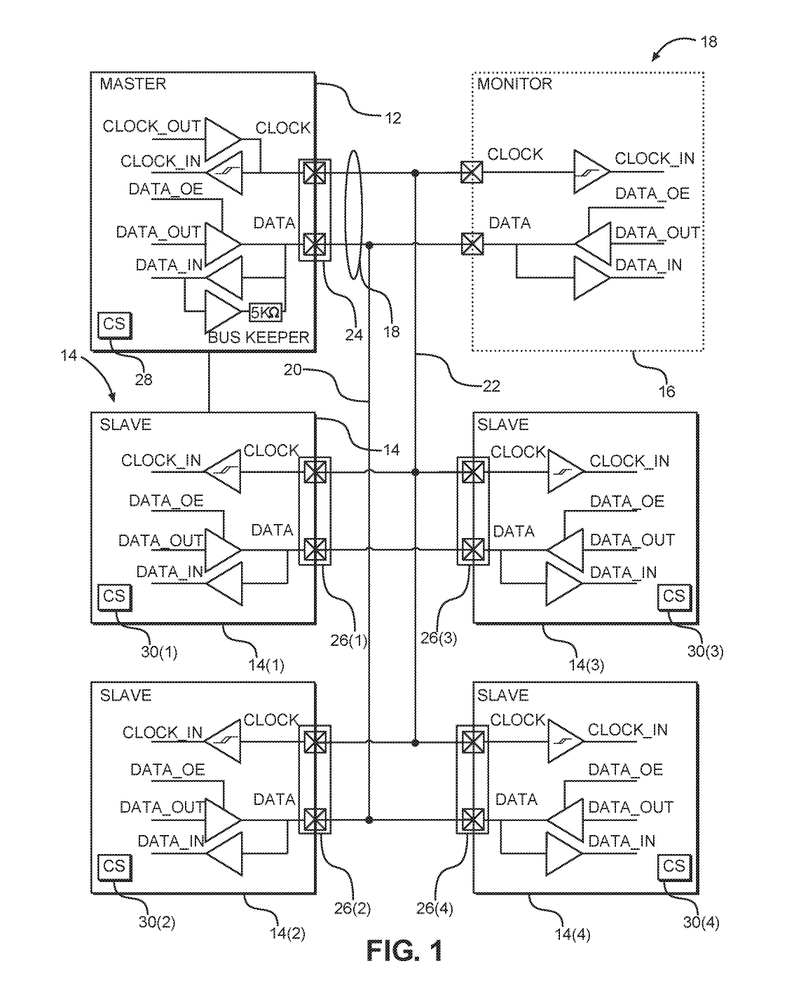

In this regard, FIG. 1 is a simplified block diagram of an exemplary SOUNDWIRE system 10. While the discussion presented herein focuses on a SOUNDWIRE system such as the SOUNDWIRE system 10, it should be appreciated that exemplary aspects of the present disclosure may be extended to other communication systems and other audio systems are particularly contemplated. The SOUNDWIRE system 10 includes a master 12 and one or more slaves 14. As illustrated, the SOUNDWIRE system 10 includes four slaves 14(1)-14(4). Optionally, a monitor 16 may be included in the SOUNDWIRE system 10. The master 12, the slaves 14(1)-14(4) and the monitor 16 are coupled to an audio bus 18 (sometimes referred to herein as a SOUNDWIRE bus). The audio bus 18 is a two-wire bus including a data line 20 and a clock line 22. The master 12 may include a bus interface 24 configured to couple to the audio bus 18. Similarly, the slaves 14(1)-14(4) may include respective bus interfaces 26(1)-26-(4) configured to couple to the audio bus 18. The master 12 may further include a master control system 28 (referred to in the drawings as CS), and the slaves 14(1)-14(4) may include slave control systems 30(1)-30(4) (also referred to in the drawings as CS), respectively.

Each slave 14 has a number of data ports, which in turn have a number of possible interrupt status conditions. Note that there are a number of possible interrupts that may occur under SOUNDWIRE v1.0. These possible interrupts are summarized in Table 1 below.

TABLE 1
Possible Interrupts

| Register | Interrupt Name | Condition |
|---|---|---|
| SCP_IntStat1 | Parity Error | Mandatory |
| SCP_IntStat1 | BusClash | Mandatory |
| SCP_IntStat1 | ImpDef1 | Optional implementation |
| | | defined usage |
| DP0_IntStat | TestFail | Mandatory when data port |
| | | 0 is implemented |
| DP0_IntStat | PortReady | Mandatory when data port |
| | | 0 is implemented |
| DP0_IntStat | BRA_Fail | Mandatory when BRA |
| | | function is implemented |
| DP0_IntStat | ImpDef1 | Optional - implementation |
| | | defined usage |
| DP0_IntStat | ImpDef2 | Optional - implementation |
| | | defined usage |
| DP0_IntStat | ImpDef3 | Optional - implementation |
| | | defined usage |
| DPN_IntStat | TestFail | Mandatory when data port |
| | | N is implemented |
| DPN_IntStat | PortReady | Mandatory when data port |
| | | N is implemented |
| DPN_IntStat | ImpDef1 | Optional - implementation |
| | | defined usage |

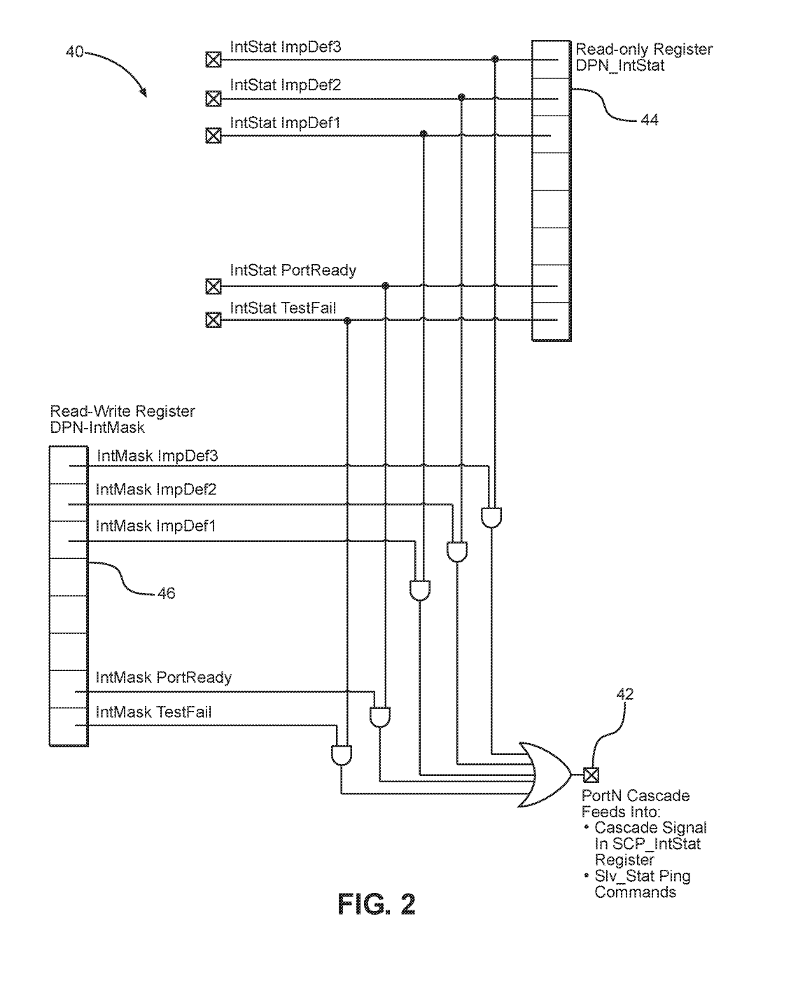

FIG. 2, reproduced from the SOUNDWIRE specification, illustrates a circuit 40 that would provide behavior of an interrupt status logic in a single data port 42. This logical functionality is duplicated for each data port that exists in each slaves 14. In particular, the circuit 40 includes a read-only register 44 that includes information relating to an interrupt status (IntStat) of the data port 42. Likewise, the circuit 40 includes a read-write register 46 with information relating to an interrupt mask (IntMask). IntStat conditions are combined with IntMask control signals to yield five IntActive signals which are logically ORed together to produce a PortN_cascade signal, which is readable in another IntStat register further up the interrupt hierarchy.

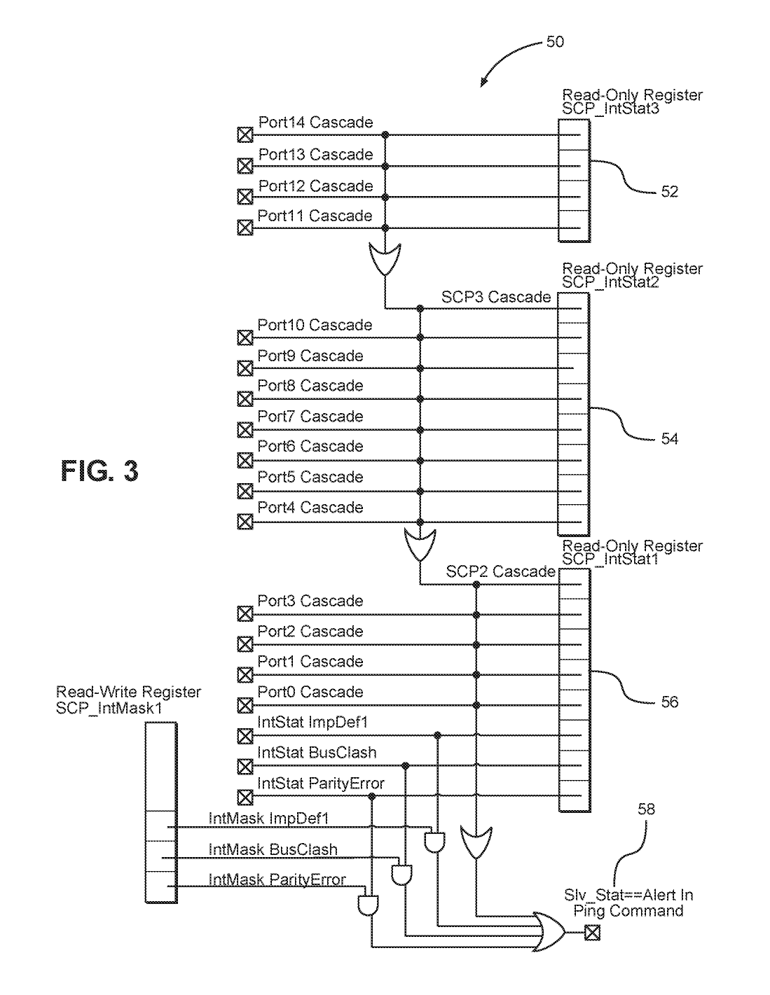

FIG. 3, also reproduced from the SOUNDWIRE specification, illustrates a circuit 50 that provides the behavior of the interrupt status logic in a slave control port (SCP). In particular, a read-only SCP_IntStat3 register 52 provides access to cascade signals from the four highest-numbered data ports. These four cascade signals are logically ORed together to provide an SCP3_cascade signal, which along with cascades from an additional seven data ports, is readable in SCP_IntStat2 register 54. Those eight signals are in turn combined in a similar way to provide an SCP2_cascade signal, which along with the cascades from the final four data ports, is readable in SCP_IntStat1 register 56. Two IntStat signals relating to top-level status conditions and an implementation-defined status condition are also readable in the SCP_IntStat1 register 56.

With continued reference to FIG. 3, the logical OR of all the cascades, plus masked versions of the two slave-level IntStat conditions yields an overall slave status which can affect the value signaled on Slv_Stat_NN bit slots of a control word during a ping command (noted generally at 58).

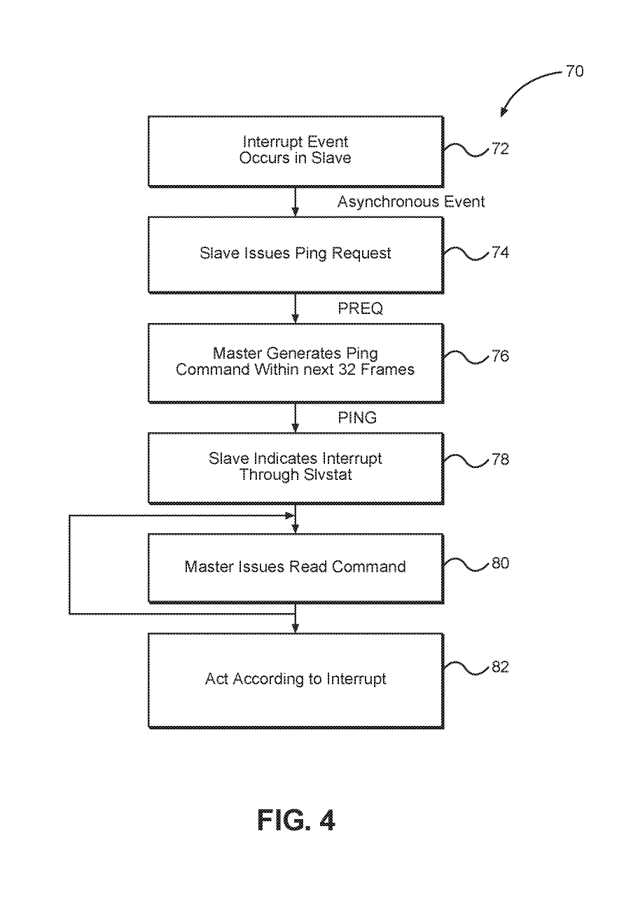

A process 70 for detecting which of many possible interrupt status logic elements within which of many possible data ports has triggered a particular interrupt is illustrated in FIG. 4. In this regard, FIG. 4 begins with an interrupt event occurring in a slave of the one or more slaves 14 of FIG. 1 (block 72). The circuit 40 of FIG. 2 captures this event in the read-only register 44 and outputs a one (1) at the data port 42. This one (1) at the data port 42 is cascaded and ORed with other data port values to output a one (1) at the Slv_Stat_NN bit slots. The slave then issues a Ping Request (referred to in the drawings as PREQ) (block 74). The master 12 detects the Ping Request and generates a PING command within the next thirty-two (32) frames (block 76). Any of the one or more slaves 14 that has an interrupt indicates so through slave status information (SlvStat) within designated bits of the PING command (block 78). The master 12 then issues a read command for the indicated slave 14 (block 80). The read command is for a single register within the slave 14. The read command initially reads each of the SCP_IntStat registers 52, 54, and 56 of FIG. 3 to locate which of the SCP_IntStat registers 52, 54, and 56 has a port cascade bit. Once the port cascade bit has been identified, the master 12 issues read commands to step through the other data ports 42 to find which data port had the interrupt. Once the data port 42 is identified, the read-only register 44 is read to determine the actual cause of the interrupt, and the master 12 can act according to the interrupt (block 82). Each time a register is read, a separate read command is required. As is readily apparent, the repetitive read commands add much latency to the process 70.

Exemplary aspects of the present disclosure greatly reduce the latency of the SOUNDWIRE system 10 of FIG. 1 by eliminating the need to step through each register iteratively to find the correct data port and then step through another register to find out what caused the data port to request the interrupt. To the extent that such interrupts may be caused by overheating or audio clipping, the elimination of the latency allows such problems to be addressed quickly and improve the user's experience with the device.

In this regard, exemplary aspects of the present disclosure provide a new command, termed herein slave interrupt status (sometimes referred to as SIS) command, for reporting a specific slave interrupt status. The new command may be signaled by using a reserved Opcode. Table 2 shows which Opcodes are available under the SOUNDWIRE specification.

TABLE 2
SOUNDWIRE OPCODES

| Value in Opcode field | Command Name |
|---|---|
| B000 | PING |
| B001 | Reserved |
| B010 | Read |
| B011 | Write |
| B100 | Reserved |
| B101 | Reserved |
| B110 | Reserved |
| B111 | Reserved |

By using one of the reserved Opcodes, the present disclosure preserves backwards compatibility because the SOUNDWIRE specification requires a slave not perform an action in response to receipt of a reserved Opcode. Thus, if a legacy device receives an SIS command using a reserved Opcode, the legacy device will ignore the SIS command. Conversely, slaves that incorporate exemplary aspects of the present disclosure will recognize the reserved Opcode and operate as outlined herein.

Exemplary aspects of the present disclosure add a new implementation-defined (Imp_def) register to the master 12 of FIG. 1 and the one or more slaves 14 that indicate what reserved Opcode is dedicated for the SIS command. Each Imp_def register will have a default value for the SIS command Note that if a future version of SOUNDWIRE utilizes the reserved Opcode designated for the SIS command, a different reserved Opcode may be used and the Imp_def register updated accordingly.

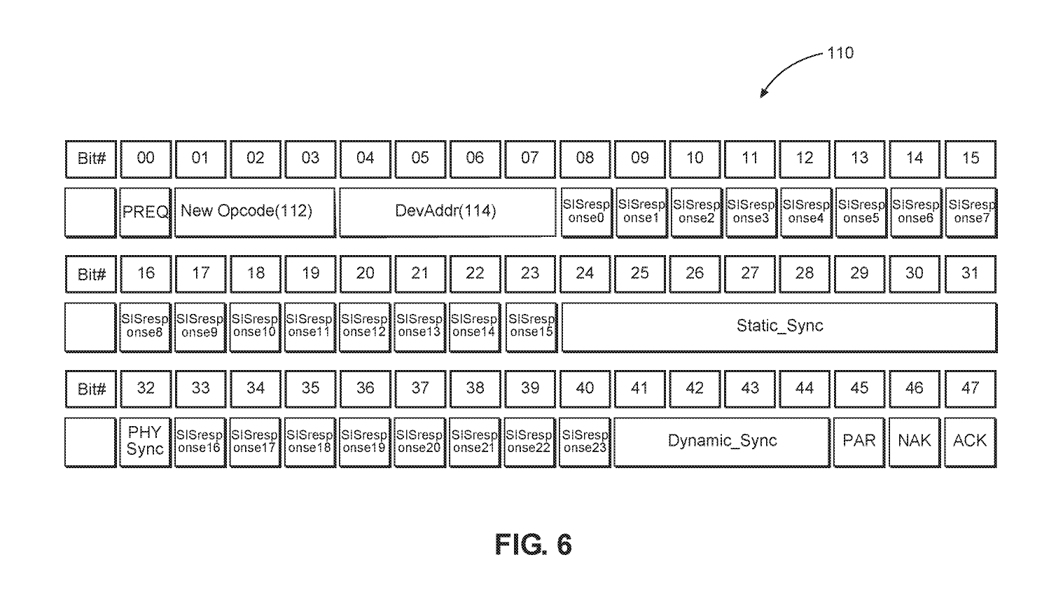

Adding the SIS command changes the process for interrupt control as better illustrated by process 90 of FIG. 5. The process 90 begins in much the same manner that the process 70 of FIG. 4 begins. An interrupt event occurs in a slave of the one or more slaves 14 of FIG. 1 (block 92). The circuit 40 of FIG. 2 captures this event in the read-only register 44 and outputs a one (1) at the data port 42. This one (1) at the data port 42 is cascaded and ORed with other data port values to output a one (1) at the Slv_Stat_NN bit slots. The slave then issues a Ping Request (block 94). The master 12 detects the Ping Request and generates a PING command within the next thirty-two (32) frames (block 96). Any of the one or more slaves 14 that has an interrupt indicates (thereby becoming an indicated slave 14) so through SlvStat within designated bits of the PING command (block 98). Note that use of the PING command and the SlvStat allows backwards compatibility to be maintained. The master 12 then issues the SIS command for the indicated slave 14 (block 100) using the reserved Opcode. The slave 14 responds with detailed interrupt status bits as better illustrated by frame 110 illustrated in FIG. 6.

With continued reference to FIG. 5, the master 12 then stores all slave status interrupts locally (block 102). The master 12 determines if the slave 14 responded to the SIS command (block 104). If the answer to block 104 is no, there is no response to the SIS command, then the master 12 iteratively reads through the registers (block 106) as described above for block 80 of FIG. 4. If, the answer to block 104 is yes, or after reading iteratively through the registers, the master 12 then acts according to the interrupt (block 108). As noted above, elimination of the iterative step 80 of the process 70, greatly reduces latency. Note that while the process 90 assumes that the master 12 sends the SIS command in response to the Ping request, PING command sequence, it should be appreciated that the master 12 may send the SIS command after some other trigger event or periodically without having received the Ping request.

FIG. 6 illustrates a frame 110 that is the slave 14 response to the SIS command. In particular, the frame 110 includes a new Opcode 112 and a device address 114 from the master 12 of FIG. 1. Then subsequent bits 08-23 and 33-40 may include up to twenty-four interrupt status bits, which may correspond to any one of the SCP_IntStat registers and any one of the data ports.

Note that the mapping of the twenty-four interrupt status bits may be fixed and mandated by the audio standard (e.g., if SOUNDWIRE were modified to include aspects of the present disclosure), they may be configurable per device according to an implementation-defined setup, or some mix thereof such that a few bits are mandatory and the others are implementation-defined. Note that a few bits may be reserved for ParityFail and/or BusClash interrupts.

Masters and slaves that use audio bus interrupts according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

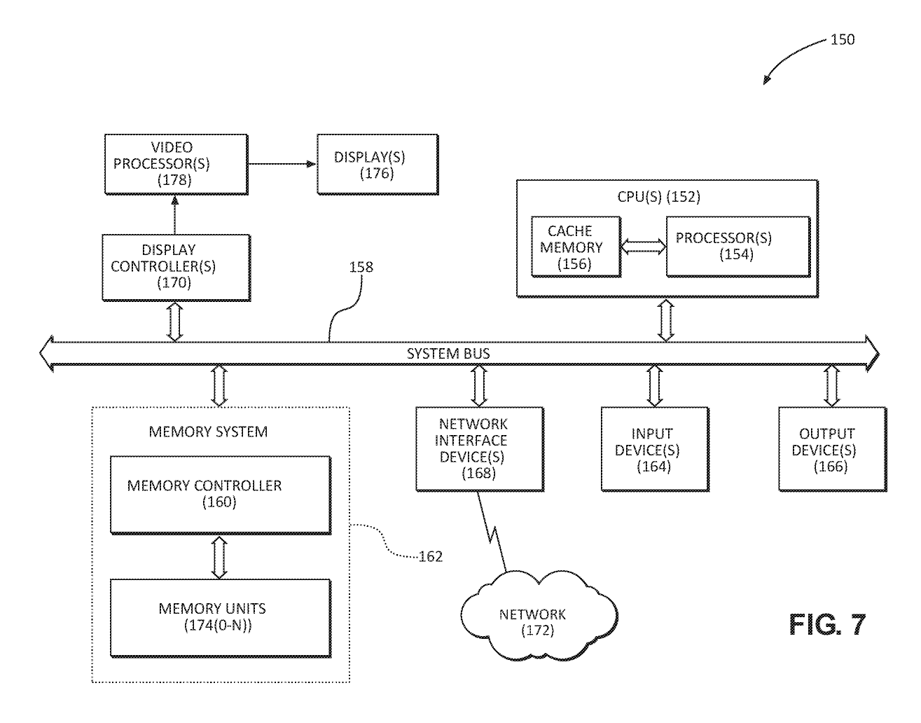

In this regard, FIG. 7 illustrates an example of a processor-based system 150 that can employ the SOUNDWIRE system 10 illustrated in FIG. 1. In this example, the processor-based system 150 includes one or more central processing units (CPUs) 152, each including one or more processors 154. The CPU(s) 152 may be the master 12. The CPU(s) 152 may have cache memory 156 coupled to the processor(s) 154 for rapid access to temporarily stored data. The CPU(s) 152 is coupled to a system bus 158 and can intercouple master and slave devices included in the processor-based system 150. As is well known, the CPU(s) 152 communicates with these other devices by exchanging address, control, and data information over the system bus 158. For example, the CPU(s) 152 can communicate bus transaction requests to a memory controller 160 as an example of a slave device. Although not illustrated in FIG. 7, multiple system buses 158 could be provided, wherein each system bus 158 constitutes a different fabric.

Other master and slave devices can be connected to the system bus 158. As illustrated in FIG. 7, these devices can include a memory system 162, one or more input devices 164, one or more output devices 166, one or more network interface devices 168, and one or more display controllers 170, as examples. The input device(s) 164 can include any type of input device, including, but not limited to, input keys, switches, voice processors, etc. The output device(s) 166 can include any type of output device, including, but not limited to, audio, video, other visual indicators, etc. The network interface device(s) 168 can be any devices configured to allow exchange of data to and from a network 172. The network 172 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 168 can be configured to support any type of communications protocol desired. The memory system 162 can include one or more memory units 174(0-N).

The CPU(s) 152 may also be configured to access the display controller(s) 170 over the system bus 158 to control information sent to one or more displays 176. The display controller(s) 170 sends information to the display(s) 176 to be displayed via one or more video processors 178, which process the information to be displayed into a format suitable for the display(s) 176. The display(s) 176 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A master comprising:
a bus interface configured to couple to an audio bus; and
a control system operatively coupled to the bus interface, the control system configured to:
detect a ping request from a slave associated with the audio bus;
send a ping command to slaves associated with the audio bus;
receive slave status information from the slave that generated the ping request;
send a slave interrupt status command to the slave that generated the ping request; and
receive information about all interrupt registers within the slave that generated the ping request.

2. The master of claim 1 further comprising a status register configured to store response values in the information about all the interrupt registers.

3. The master of claim 1, wherein the control system configured to receive the information about all the interrupt registers is configured to receive information indicating that plural interrupt registers generated the ping request.

4. The master of claim 1, wherein the control system is configured to send the slave interrupt status command using a reserved Opcode.

5. The master of claim 1, wherein the bus interface is configured to couple to a SOUNDWIRE audio bus.

6. The master of claim 1, wherein the control system is configured to receive first information about all interrupt registers within a first slave that generated the ping request and to receive second information about all interrupt registers within a second slave that generated the ping request.

7. The master of claim 6, wherein the first information is formatted differently than the second information.

8. The master of claim 2, wherein the control system is further configured to clear the stored response values following receipt of a command.

9. The master of claim 1 integrated into an integrated circuit (IC).

10. The master of claim 1 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

11. A method for generating an interrupt, comprising:
detecting a ping request from a slave associated with an audio bus;
sending a ping command to slaves associated with the audio bus;
receiving slave status information from the slave that generated the ping request;
sending a slave interrupt status command to the slave that generated the ping request; and
receiving information about all interrupt registers within the slave that generated the ping request.

12. The method of claim 11 further comprising storing response values in the information about all the interrupt registers in a status register.

13. The method of claim 11, wherein receiving the information about all the interrupt registers comprises receiving information indicating that plural interrupt registers generated the ping request.

14. A slave comprising:
a bus interface configured to be coupled to an audio bus;
an audio component; and
a control system operatively coupled to the audio component and the bus interface, the control system configured to:
set a ping request bit in a frame on the audio bus in response to an interrupt situation being detected within a slave;
receive a ping command from a master through the audio bus;
respond to the ping command with a slave status information;
receive a slave status interrupt command from the master through the audio bus; and
send information about all interrupt registers on the audio bus to the master.

15. The slave of claim 14 further comprising a plurality of cascaded interrupt registers.

16. The slave of claim 14 wherein the control system is preprogrammed with a format for a slave status interrupt response to send the information about all the interrupt registers to the master.

17. The slave of claim 14, wherein the control system is configured by the master to provide an implementation-defined format for a slave status interrupt response to send the information about all the interrupt registers to the master.

18. The slave of claim 14, wherein the audio bus is a SOUNDWIRE audio bus.
